(19) United States
(12) Patent Application Publication
(10) Pub. No.: US 2007/0083918 A1
(43) Pub. Date: Apr. 12, 2007

(54) Validation of call-out services transmitted over a public switched telephone network

(75) Inventors: Christopher E. Pearce, Dallas, TX (US); Cullen Jennings, San Jose, CA (US)

Correspondence Address: BURGESS & BEREZNAK LLP, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/247,704

(22) Filed: Oct. 11, 2005

(51) Int. Cl. H04L 9/32

(52) U.S. Cl. 726/5

(57) ABSTRACT

A server for authenticating call-out services over a public switched telephone network (PSTN) includes a memory, a port to receive information provided by a caller over the PSTN, the information including ciphertext, and a processor operable to use the information to look-up a value in the memory and to perform a calculation that produces a result utilizing an algorithm. The processor authenticates the caller if the ciphertext matches a set of initial bytes of the result. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

The present invention relates generally to the fields of data networks and communication systems; more specifically, to electronic security systems and authentication techniques for communications over a telephone network.

### BACKGROUND OF THE INVENTION

Enterprise organizations are constantly striving for productivity improvements that lower operational costs. One approach that has extended the productivity zone of workers and processes is a telecommuting scenario that provides employees with access to corporate applications at their home. Productivity gains may also be realized by tightly integrating business telephone systems with employee cellular telephones. For example, many enterprises can benefit from a system that allows an employee to answer incoming phone calls to an employee's desk phone on their cell phone, as well as place outgoing calls from their cell phone that route through the enterprise phone system. Supporting this feature requires anchoring the call in the enterprise.

While calls to a worker's desk phone naturally anchor and can trigger the outbound call to the cell phone, calls from the cell phone do not naturally anchor. Cisco® System's MobileConnect™ product, which performs single number reachability functions, addresses this issue by creating an interactive voice response (IVR) system script that a user in a cellular network can access to place outbound calls. Basically, users dial a number to access the IVR, and upon being prompted, enter the outgoing number they want to call. Although this approach anchors the outbound call in the enterprise, it creates a toll fraud risk since unauthorized persons may use the IVR to place calls that are billed to the enterprise.

Another technique for integrating business telephone systems with employee cellular telephones is through the use of dual radio cell phones, in which a cellular telephone protocol across a cellular radio network is utilized when the user is outside the enterprise and a voice over Internet protocol (VoIP) across wireless networking is utilized when the user is inside the enterprise. Motorola™ sells a business phone that supports a similar feature referred to as “meet-me conferencing, which allows a user to enter a conference by simply dialing an available conference number—the number providing a virtual rendezvous point for callers. However, the problem with business phones with features such as Motorola's meet-me conferencing is that a toll fraud risk similar to that described above is created when a call is exposed to a public network.

Common prior art attempts to overcome the problem of fraudulent access to business phone and conferencing systems include requiring authorized users to enter a personal identification number (PIN). Mechanisms for validating the caller ID are also widely used. By way of example, U.S. Pat. No. 6,839,761 teaches a method and system for authentication through multiple proxy servers that require different authentication data such as user IDs and passwords. The drawback of this approach, however, is that user PINs can easily be leaked by phone users and are also vulnerable to various attacks. Tools commonly used by hackers to compromise users' passwords and network security include sniffing (in which hackers steal passwords transmitted over wireless networks), brute force attacks, dictionary attacks, and personal information gathering. Additionally, a caller ID can be entirely spoofed without much difficulty in a public network.

A variety of protocols and security algorithms have been developed to address the need for authenticating users who attempt to access a network. For example, Request for Comments (RFC) 2617 specifies a standard for HyperText Transport Protocol (HTTP) Digest Authentication. HTTP Digest Authentication defines a protocol that allows a client (i.e., a program or device that establishes connections for the purpose of sending requests) to prove to a server (i.e., an application program or device that accepts connections in order to service requests by sending back responses) that it knows the correct password without having to send the password itself to the server.

In HTTP Digest Authentication when a client attempts to obtain network service, the server generates a random value (called a nonce) and issues a challenge containing the nonce to the client. The client then performs an irreversible computation by inputting its username, secret password, and the nonce to a secure hash function or algorithm that produces a key. (For instance, the Secure Hash Algorithm, SHA-1, specifies a standard for computing a condensed representation of a message or data file. When a message of any length<2⁶⁴ is input, the SHA-1 produces a 160-bit output called a message digest.) The basic idea is that since the computation is irreversible, an eavesdropper cannot obtain the secret password. The resulting key (e.g., 160-bits) is communicated to the server along with the username and nonce used for the calculation. Given the username, the server can look up the associated secret password in its database and then input the username, password, and nonce into the same hash function used by the client. If the resulting computation matches the key provided by the client, the server can be reasonably confident that client is authorized to access the network services.

One problem with HTTP Digest Authentication is that a public switched telephone network (PSTN) lacks the inherent capability to perform a standard digest authentication. The reason why is because the channels available for communication in a PSTN are typically limited to the number dialed, the caller ID (which may be spoofed in certain networks), and Dual-Tone Multi-Frequency (DTMF) signaling. In addition, certain home and cellular telephones are incapable of listening to DTMF signals. Moreover, it is often prohibitively difficult to communicate the very long text or hexadecimal string generated by a secure hash algorithm over a PSTN.

Thus, what is a needed is a new system and method that solves the problem of validating/authenticating users who wish to access network services via communications over a PSTN.

By way of further background, U.S. Pat. No. 6,876,734 teaches an Internet-enabled conferencing system accommodating PSTN and Internet Protocol (IP) traffic. U.S. Pat. No. 6,931,001 discloses a system for interconnecting packet-switched and circuit-switched voice communications. U.S. Pat. No. 6,816,469 teaches an IP telephony network and PSTN that allows one or more call waiting callers to dynamically join in an existing multiple party conference call session. U.S. Pat. No. 6,839,761 teaches a method and system for authentication through multiple proxy servers that require different authentication data such as user IDs and passwords. A system for securely sharing log-in credentials among a restricted and authorized set of trusted applications is also taught in U.S. Pat. No. 6,438,600. An authentication system that utilizes simultaneous communications on two different networks to verify a user's identity is described in U.S. Pat. No. 6,934,858. Finally, U.S. Pat. No. 6,643,774 teaches an authorization method to enable servers using public key authentication to obtain user credentials in the form of tickets from a private key system, the tickets identifying a user's access rights and privileges.

### BRIEF DESCRIPTION OF THE DRAWINGS

The present invention will be understood more fully from the detailed description that follows and from the accompanying drawings, which, however, should not be taken to limit the invention to the specific embodiments shown, but are for explanation and understanding only.

FIG. 1 is a block diagram of an exemplary validation system according to one embodiment of the present invention.

FIGS. 2A & 2B illustrate a flow diagram of multiple different embodiments of the present invention.

FIG. 3 is a diagram that shows a method in accordance with one embodiment of the present invention.

FIG. 4 is a generalized circuit schematic block diagram of a network node.

### DETAILED DESCRIPTION

A solution for validating/authenticating call-out network services over a PSTN is described. In the following description specific details are set forth, such as device types, protocols, configurations, etc., in order to provide a thorough understanding of the present invention. However, persons having ordinary skill in the networking arts will appreciate that these specific details may not be needed to practice the present invention.

In general, a communication network is a geographically distributed collection of interconnected subnetworks for transporting data (e.g., voice signals) between nodes, such as intermediate nodes and end nodes. Examples of the end nodes may include servers, intelligent telephone devices, and personal computers. The nodes typically communicate by exchanging data according to predefined protocols. In this context, a protocol consists of a set of rules defining how the nodes interact with each other.

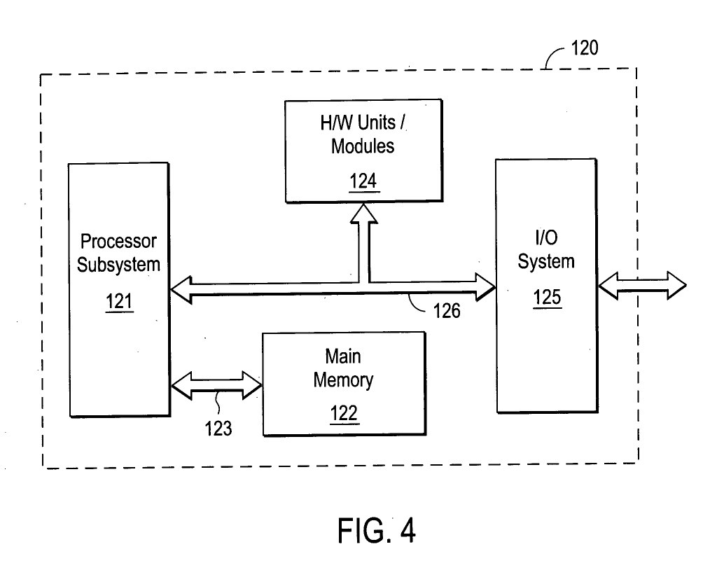

As shown in FIG. 4, a node 120 typically comprises a number of basic subsystems including a processor subsystem 121, a main memory 122 and an input/output (I/O) subsystem 125. Data is transferred between main memory (“system memory”) 122 and processor subsystem 121 over a memory bus 123, and between the processor and I/O subsystems over a system bus 126. Examples of the system bus may include the conventional lightning data transport (or hyper transport) bus and the conventional peripheral component [computer] interconnect (PCI) bus. Node 120 may also comprise other hardware units/modules 124 coupled to system bus 126 for performing additional functions. Processor subsystem 121 may comprise one or more processors and a controller device that incorporates a set of functions including a system memory controller, support for one or more system buses and direct memory access (DMA) engines. In general, the single-chip device is designed for general-purpose use and is not heavily optimized for networking applications.

In accordance with one embodiment of the present invention, HTTP Digest authentication is adapted for calls over a PSTN to more strongly secure an enterprise's IVR and/or conference bridges. Password or other validating credential information may be provided by a caller to an authentication server using a variety of different techniques, including IVR-based, subaddress-based, and calling number based methods. In various alternative embodiments, authentication may be performed using Asymmetric Encryption, one-time password, or other algorithms/methods to validate the caller's password information.

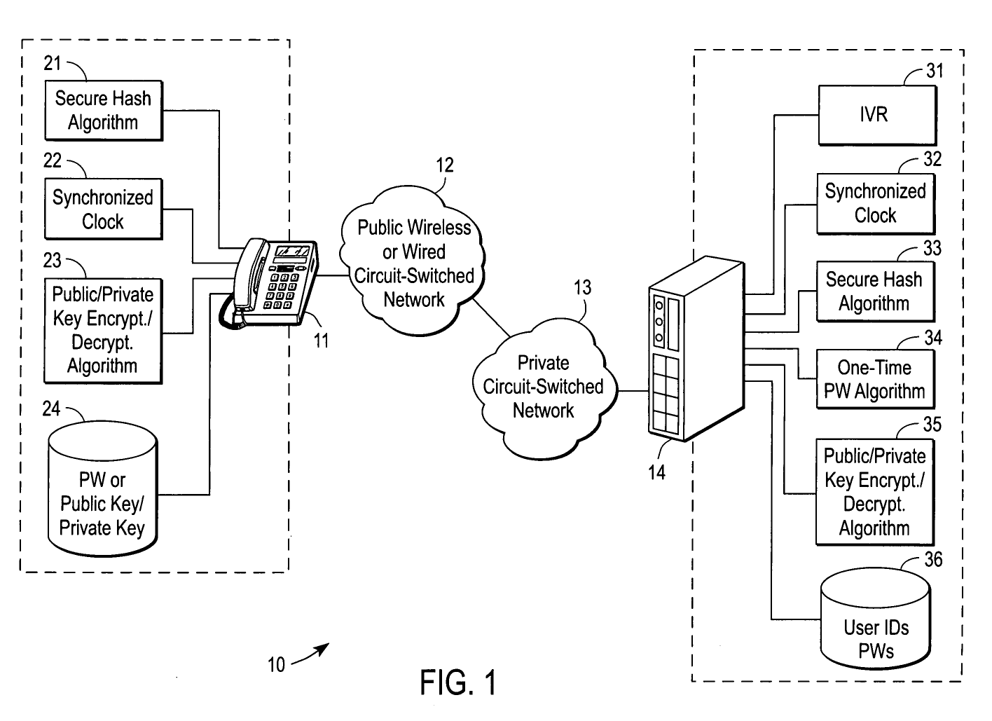

FIG. 1 is a diagram showing an exemplary network topology and system according to one embodiment of the present invention, wherein a non-IP client telephone device 11 (left side) having a keypad is shown connected with an authentication server 14 (right side) via a public wireless or wired circuit-switched network 12 and a private circuit-switched network 13. Although telephone device 11 is depicted as a conventional desk handset device, it is appreciated that device 11 may comprise any one of a number of different telephone devices, including a cellular telephone, hybrid cellular/wireless telephone, analog telephone, or other devices configured for communications over public circuit-switched network 12. Similarly, network 13 may comprise a private telephone network that includes a private branch exchange (PBX) commonly used within many business organizations and enterprises.

Furthermore, it should be understood that additional networks and network devices (not shown) may be utilized for the purpose of connecting client device 11 with server 14. For instance, the connection path between client device 11 and server 14 may include a VoIP gateway device connected with an IP network that routes to a PSTN phone number. The caller ID approach described below is also applicable to telephone devices connected to a PSTN via Integrated Services Digital Network (ISDN) interfaces such as Basic Rate Interface (BRI), Primary Rate Interface (PRI), or VoIP interfaces (Session Initiation Protocol/H.323) that may route onto a PSTN.

With continuing reference to the example of FIG. 1, client telephone device 11 is shown configured with hardware and/or software component elements or modules implementing a secure hash algorithm 21, a synchronized clock 22 for synchronizing communications with server 14, a public/private key encryption/decryption algorithm 23, and a storage element 24 to store a password (PW) or a public/private key. By way of example, storage element 24 may comprise a RAM, ROM, hard-disk, or flash EPROM memory device. Practitioners will appreciate that client telephone device 11 need not include all of the components shown. For instance, in a specific implementation, device 11 may comprise a cell phone configured with secure hash algorithm 21, synchronized clock 22, and storage element 24, with no public/private key encryption/decryption algorithm 23. In another case, device 11 may be configured with public/private key encryption/decryption algorithm 23, but no secure hash algorithm 21. In other words, the specific encryption algorithm or method used for authenticating a caller may vary in different embodiments.

On the server side of FIG. 1, authentication server 14 is shown including an IVR 31, a synchronized clock 32, a secure hash algorithm 33, a one-time password algorithm 34, a public/private key encryption/decryption algorithm 35, and a memory 36 for storing user IDs and passwords. In the case of asymmetric encryption methods, memory 36 may be replaced with a Public Key Infrastructure (PKI), which could function as a repository of the public key for a given user. As explained above with reference to the client side, different specific implementations of server 14 may utilize a single algorithm to perform authentication to the exclusion of other algorithms or methods. For example, in one embodiment server 14 may perform authentication utilizing the known one-time password method. Another embodiment may utilize an asymmetric encryption algorithm for the authentication process to the exclusion of Digest and one-time password (OTP) methods. In yet another embodiment, only Digest authentication may be used.

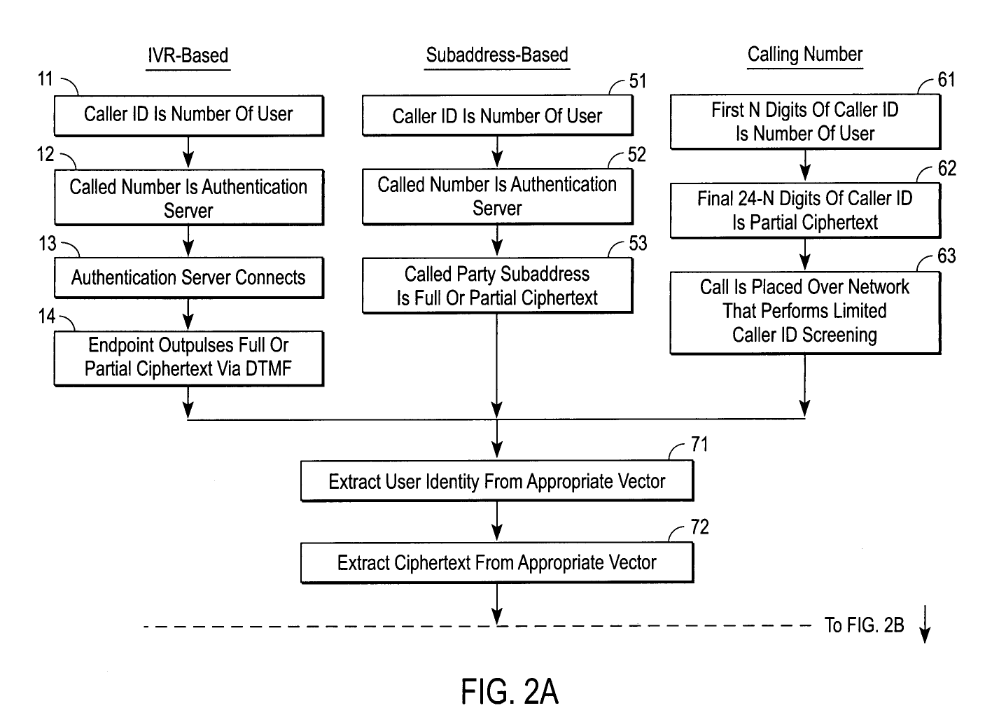

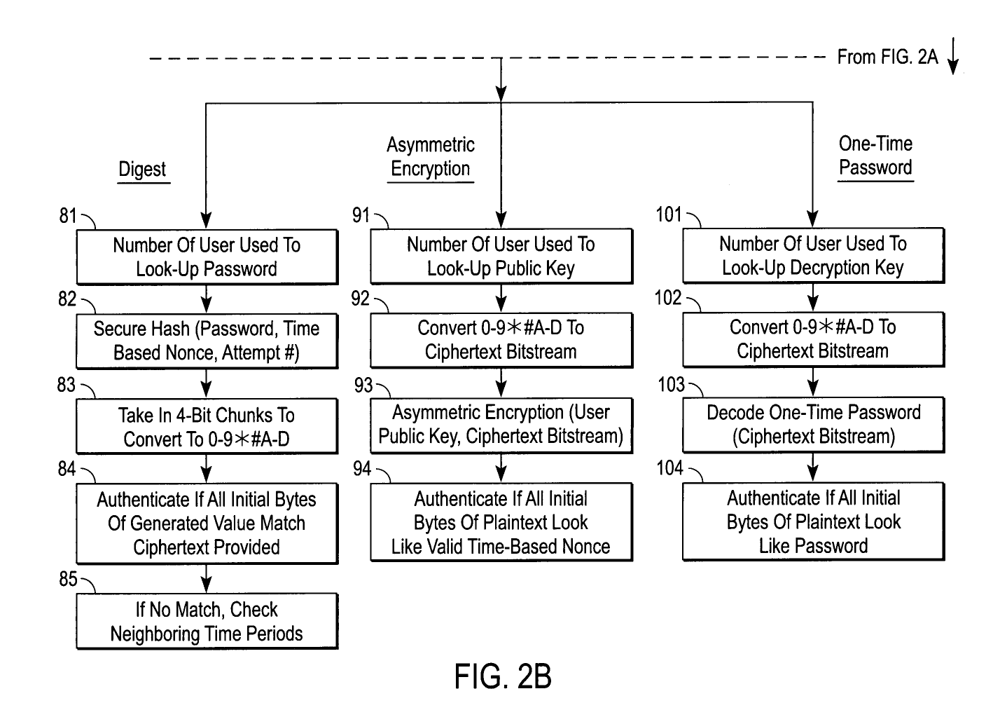

FIGS. 2A & 2B are a flow diagram that illustrates the process of providing password information and authenticating a client's network access privileges in accordance with several alternative embodiments of the present invention. The top side (FIG. 2A) of the diagram shows three different alternative techniques by which the client device may provide the password information to the authentication server. Each of these techniques involves sending either a calculated result (e.g., a key produced by a secure hash algorithm) or other encrypted password information along with some user identity information that identifies the user or caller (e.g., a caller ID or user ID). The calculations and sending of the result to the server is typically performed in response to an input to the keypad. The bottom of FIG. 2A shows the extraction of the user information, e.g., username or caller ID, (block 71) from the ciphertext message (block 72) generated by the client device. Ciphertext is information that has been encrypted into seemingly meaningless code. A ciphertext message has a form that cannot be understood by unauthorized parties, and is created from plain text by a certain encryption algorithm. (Practitioners in the art will understand that the term “vector” in FIG. 2A refers to the encoding of the user information and ciphertext together in the communication signals output by client telephone device 11.)

For example, in the case of HTTP Digest authentication, the ciphertext message produced by the client device may be the partial result of inputting a nonce, username, and password into a secure hash algorithm. The nonce, itself, may be generated by an algorithm running in both the client and server devices, and may change over time. Alternatively, the nonce may be replaced with a value that changes according to a time schedule (e.g., the value changing every 15 minutes). A time-sensitive nonce, for example, could be a combination of a given time interval plus additional information, such as the number of successful authentication attempts made by the client during a given time interval, or the number of successful authentication attempts made by the client over the lifetime of the system.

In a typical implementation, client device 11 may provide password information via an IVR, wherein the calling number is the user ID or caller ID (block 11) and the called number is authentication server 14 (block 12). After the authentication server connects with the client device (block 13) the client is prompted for the full or partial ciphertext, which consists of a string of digits (i.e., 0-9,*,#,A-D) that contain the caller ID and key result. By way of example, the user may press a button on their telephone to invoke a function that calculates a hash value or key, and then provides that hash value (full or partial) to the IVR. The ciphertext may be outpulsed by the client device to the server via standard DTMF signals.

In another embodiment, password information may be provided via a standard subaddress-based method in which the caller ID is the telephone number of the client device (block 51), and the called number is the authentication server (block 52). In this case, the called party subaddress is the full or partial ciphertext transmitted to the server (block 53). For example, the ciphertext containing the encrypted password may constitute a string of digits added onto the end of the ten digit caller ID.

Another alternative method for communicating user password information utilizes variable-length dial plans (such as in Germany) in which callers may tack additional digits directly onto the called number. These additional digits could be interpreted by the server as the user password information.

Yet another way of providing user password information to the server is through the use of an ordinary called number scheme. An IVR normally has only a single telephone number. However, the authentication system may be configured so that multiple called numbers route to the IVR associated with the authentication server. According to the calling number method shown in FIG. 2A, the user's password information is implicit in the number used to dial the IVR, which may change on each subsequent connection attempt. Thus, the first N digits of the caller ID may comprise the telephone number of the user (block 61), with the final 24-N digits of the caller ID representing the partial ciphertext (block 62). It is appreciated that caller ID screening should not be used by the intervening networks when using the caller ID method of communicating the user password.

In still yet alternative method (not shown in FIG. 2B) password information may be communicated through the number dialed by the user when calling the IVR of the server. In this scheme the IVR is assigned a range of addresses or calling numbers. For instance, the IVR may be assigned a range of one thousand phone numbers (e.g., 972-813-0000 to 972-813-9999) with calls to all of these numbers routing to the IVR. The caller ID (i.e., caller's telephone number) identifies the calling user to the authentication server and the specific number dialed representing the password. For example, a particular caller may be required to dial 972-813-1234, since that number has been designated as their unique password when calling the IVR. A call from that user to any other number in the range of IVR numbers is treated as an invalid password.

Practitioners will also appreciate that the above-described approach may also be modified using an algorithm which changes the password (i.e., calling number) on a call-by-call or time period basis. For instance, the first time a user calls the IVR, he may be required to dial 972-813-1414, whereas the next time the same user calls, he may be required to dial 972-813-2512. In other words, the password assigned to a particular user changes each time he calls the IVR.

Regardless of the method that is used to provide the client's password information, once the server receives the call vector from the client device, the authentication server separates the vector field into the caller ID (block 71) and ciphertext that contains the encrypted password (block 72). In one embodiment, the client simply partitions the calling party information element into two pieces: the first N digits representing the client's PSTN number (i.e., caller ID or username) and the last M digits representing the initial digits of the secure hash result.

FIG. 2B illustrates three different alternative authentication techniques that may be used in accordance with the present invention irrespective of the way that the password information has been provided to the server. In other words, any of the authentication methods (i.e., Digest, asymmetric encryption, or OTP) shown in FIG. 2B may be utilized in conjunction with any of the methods for providing the user password (i.e., IVR, subaddress, or calling number) shown in FIG. 2A.

As previously discussed, authentication may be performed using HTTP Digest authentication in which the number of the user (e.g., the caller ID) is used by authentication server 14 to look up the associated user password in memory 36 (block 81). In the example shown, server 14 then passes the password, time-based nonce, and the attempt number through secure hash algorithm 33 (block 82). (The attempt number and/or time-based parameters may be optionally included to guard against replay or brute force attacks.) The random nonce is generated by server 14 on a session-by-session basis and may be communicated to the client by IVR 31. Before client telephone transmits the call vector to server 14, device 11 inputs its caller ID, nonce, and password into secure hash algorithm 21, which is the same as hash algorithm 33 used by server 14. The key result is communicated to server 14 as ciphertext.

According to the embodiment shown, the resulting key produced by secure hash algorithm 33 in authentication server 14 is a long ciphertext string that is taken in 4-bit chunks and converted to a string of digits (i.e., 0-9,*,#,A-D) (block 83). The caller is authenticated if all of the initial bytes of the value generated by secure hash algorithm 33 match the ciphertext provided by the caller (block 84). In the event that there is no match, the secure hash function may be retried using a nonce generated in the preceding or subsequent time period (block 85). In other words, it is possible that clocks 32 and 22 may not be precisely aligned or synchronized. For instance, the nonce value may change every 15 minutes such that the ciphertext generated by hash algorithm 21 is produced on one side of the time boundary (several minutes earlier) and the result generated by hash algorithm 33 is produced on the other side of the time boundary (several minutes later).

By way of further example, if a client had placed three calls within the preceding time period, upon validating the first call in the next time period, the server may find that the hash for H(username, password, nonce=[period N, attempt x]) might result in a mismatch. However, analyzing H(username, password, nonce=[period N+1, attempt x]) for the next time period, or H(username, password, nonce=[period N−1, attempt x]) for the previous time period, might result in a match, revealing that the client are not precisely synchronized in the same time period. Likewise, with respect to a mismatch of the attempt number, the server might check for the first attempt in the next time period or the m+1th attempt in the previous time period, where m is the number of successful attempts that occurred within that time window; that is, H(username, password, nonce=[period N+1, attempt 1]) or H(username, password, nonce=[period N−1, attempt m+1]).

An important aspect of the present invention is that a caller may be authenticated by the server based only a match of an initial set of M bytes of the computed key or result of the security algorithm. That is, the full hash string computed by the client telephone device need not be sent to the authentication server. Since the communication channels available for transmitting data in a PSTN are usually constrained, client telephone device 11 may only communicate the first M digits of the computed ciphertext string, i.e., a partial ciphertext string. The server may still compute the full string, but validation of the caller is based on a match of an initial set of bytes received. In other words, when the authentication information is so long that it becomes impractical to communicate the full ciphertext string over the PSTN, it suffices to communicate a small portion (initial M bytes or digits) of the computed result. The underlying concept is that since the security algorithm (e.g., hash, asymmetric encryption, OTP) generates a truly unpredictable value it is reasonably secure to verify that a small subset (e.g., initial M bytes) of the full result presented in the authentication information properly align.

It is appreciated that the number of matching bytes needed before the server authenticates the caller may vary in different embodiments. For instance, in embodiments that rely upon the caller ID to communicate authentication information, it may be reasonable to authenticate based on 5-7 matching bytes. In other cases, the number of matching bytes required may depend upon the level of unpredictability or randomness of the security algorithm employed.

In yet another alternative embodiment of the present invention, rather than having the server attempt to communicate a random nonce to the client, a scheme may be utilized whereby the nonce is generated (by both the server and client) according to a synchronized timetable. As described above, if no match is produced in a given time period, nonce values for neighboring time periods may be utilized in the security algorithm calculation.

With continuing reference to FIG. 2B, asymmetric encryption may be utilized as an alternative method of validation/authentication. Asymmetric Encryption is a known form of encryption where keys come in pairs—one is usually made public and the other is kept private or secret. What one key encrypts, only the other can decrypt. For example, users can send secret messages by encrypting a message with the recipient's public key. In this case, only the intended recipient can decrypt the message, since only that user should have access to the required secret key. In the example shown in FIG. 2B, the telephone number of the caller is used to look up the public key (block 91) that may be stored in memory 36 of server 14 (see FIG. 1). As discussed above, a PKI may used as the repository for the user's public key. After converting the communicated digits (0-9,*,#,A-D) to a bitstream (block 92), an asymmetric encryption/decryption algorithm may be used to authenticate against the user public key and the ciphered bitstream (block 93). In this case, the user is authenticated using matching initial M bytes of plaintext.

In still another embodiment, a one-time password (OTP) security algorithm may be utilized in which the number of the caller is used to look up a decryption key (block 101). According to the OTP scheme, a new password is generated every time a user attempts to authenticate, thus protecting against an intruder replaying intercepted password information. Practitioners will appreciate that OTP systems may generate passwords using a hashing algorithm. In any case, after converting the communicated digits to a bitstream (block 102) and decoding of the OTP (block 103), the user may be authenticated if all the initial M bytes of the converted plaintext match the OTP (block 104).

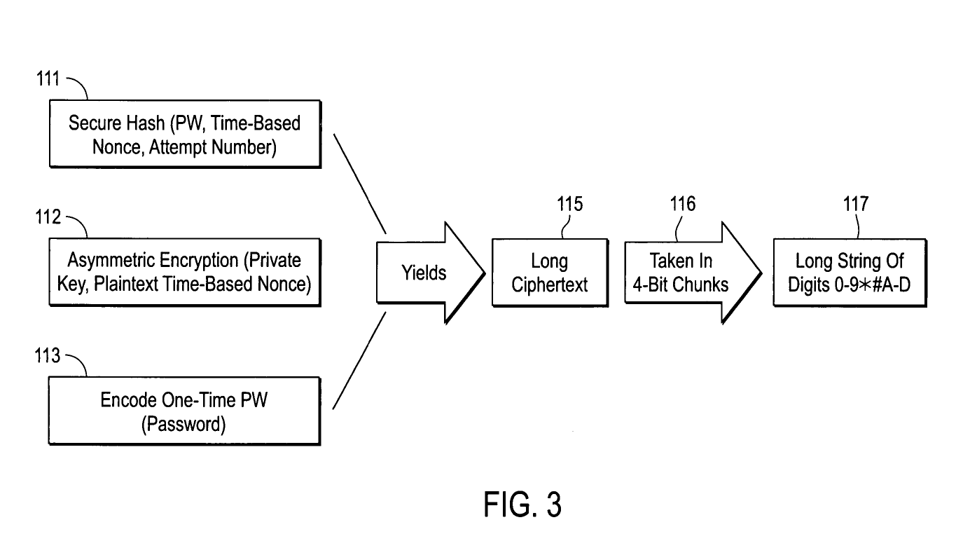

FIG. 3 is a simplified flow diagram showing basic operations according to one embodiment of the present invention. As can be seen, regardless of the process used for authentication, e.g., secure hash (block 111), asymmetric encryption (block 112), or one-time password (block 113), the result yields a long ciphertext string (block 115) that may then be taken in small chunks, e.g., 4-bit chunks, (block 116) for conversion into a corresponding string of digits (block 117). The user is subsequently authenticated when all initial M bytes/digits computed by the server match those received from the client.

It should also be understood that elements of the present invention may also be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, elements of the present invention may be downloaded as a computer program product, wherein the program may be transferred to a node or telephone device by way of data signals embodied in a carrier wave or other propagation medium via a communication link (e.g., a modem, telephone line, or network connection).

Additionally, although the present invention has been described in conjunction with specific embodiments, numerous modifications and alterations are well within the scope of the present invention. Accordingly, the specification and drawings are to be regarded in an illustrative rather than a restrictive sense.

1. A processor-implemented method of authenticating a caller over a public switched telephone network (PSTN), comprising:
receiving a call that includes a caller identification (ID) and ciphertext from the caller, the ciphertext including an value encrypted in accordance with an algorithm; and
performing a look-up to a memory location that stores a password associated with the caller;
decrypting the ciphertext using the algorithm and a decryption key to retrieve the value; and
authenticating the caller if a first M bytes of the value, where M is an integer, match a corresponding M bytes of the password.

2. The processor-implemented method of claim 1 wherein the caller ID and ciphertext are received in a vector sent over the PSTN from a client telephone device, and further comprising:
extracting the caller ID from the vector; and
extracting the ciphertext from the vector.

3. The processor-implemented method of claim 1 wherein the algorithm is a one-time password algorithm.

4. The processor-implemented method of claim 1 further comprising:
converting the first M bytes into a bitstream.

5. The processor-implemented method of claim 5 further comprising:
decoding the bitstream into plaintext.

6. A processor-implemented method of authenticating a caller over a public switched telephone network (PSTN), comprising:
receiving a caller identification (ID) and ciphertext from the user; and
performing a look-up to a memory location that stores a password associated with the caller ID;
performing a calculation using the algorithm with the caller ID and password being included as inputs, the calculation producing a result;
authenticating the caller if a first M bytes of the result, where M is an integer, match the ciphertext.

7. The processor-implemented method of claim 6 wherein the algorithm is a hash algorithm.

8. The processor-implemented method of claim 6 wherein the inputs further include a nonce value.

9. The processor-implemented method of claim 8 wherein the nonce value is a time-based nonce value.

10. The processor-implemented method of claim 6 wherein the inputs further include an attempt number.

11. The processor-implemented method of claim 6 wherein performing the calculation comprises:
converting a value generated by the algorithm into a string of digits.

12. A processor-implemented method of authenticating a user over a public switched telephone network (PSTN), comprising:
receiving a call that includes a user information and ciphertext; and
using the user information a look-up a key stored in a memory;
performing a calculation using an algorithm with the key and ciphertext being included as inputs, the calculation producing a result;
authenticating the caller if a first M bytes of the result, where M is an integer, match a valid nonce.

13. The processor-implemented method of claim 12 wherein the nonce is a time-based nonce.

14. The processor-implemented method of claim 12 wherein the algorithm is an asymmetric encryption algorithm.

15. The processor-implemented method of claim 12 wherein performing the calculation comprises:
converting a value generated by the algorithm into a string of digits.

16. A server for authenticating call-out services over a public switched telephone network (PSTN), comprising:
a memory;
a port to receive information provided by a caller over the PSTN, the information including ciphertext;
a processor operable to use the information to look-up a value in the memory and to perform a calculation utilizing an algorithm, the calculation producing a result, the processor authenticating the caller if the ciphertext matches a set of initial bytes of the result.

17. The server of claim 16 wherein the algorithm comprises a secure hash algorithm.

18. The server of claim 16 wherein the value comprises a password of the caller.

19. The server of claim 16 wherein the information comprises a caller ID.

20. The server of claim 16 wherein the value comprises a public key and the algorithm comprises an asymmetric encryption algorithm.

21. The server of claim 16 wherein the value comprises a decryption key and the algorithm comprises a one-time password algorithm.

22. The server of claim 16 further comprising:
an interactive voice response (IVR) system operable to receive the information via Dual-Tone Multi-Frequency (DTMF) signals.

23. A non-Internet Protocol (IP) telephone device comprising:
a keypad; and
means responsive to an input to the keypad for communicating password information associated with a caller to a server over a public switched telephone network (PSTN), the password information including a caller ID and ciphertext consisting of a string of digits, the means generating the ciphertext in accordance with an algorithm, the password information being used by the server to authenticate the caller.
